(19) United States
(12) Patent Application Publication
(10) Pub. No.: US 2009/0074504 A1
(43) Pub. Date: Mar. 19, 2009

(54) BALL JOINT DEVICE

(75) Inventor: Agustin Morales Arnaez, Getxo (Vizcaya) (ES)

Correspondence Address: MERCHANT & GOULD PC, P.O. BOX 2903, MINNEAPOLIS, MN, 55402-0903, US

(73) Assignee: INDUSTRIA AUXILLIAR ALAVESA, S.A. (INAUXA, S.A.), Amurrio (ES)

(21) Appl. No.: 11/969,029

(22) Filed: Jan. 3, 2008

Related U.S. Application Data
(63) Continuation of application No. 11/284,057, filed on Nov. 21, 2005, now abandoned.

(30) Foreign Application Priority Data
Nov. 25, 2004 (EP) 04380238.8

(51) Int. Cl. F16C 11/00

(52) U.S. Cl. 403/77

(57) ABSTRACT

A ball joint device having a ball joint (4), a ball joint seat (2) and a casing (1). The casing (1) has a first casing housing (10) to house the seat (2), said first casing housing (10) being configured to prevent relative movement between the casing (1) and the seat (2). The casing (1) also has a first casing end (11); a second casing end (12) opposite to the first casing end (11) having first joining elements (120) between the casing (1) and the seat (2); an intermediate portion (13) in the first casing housing (10) between the first casing end (11) and the second casing end (12), said intermediate portion (13) having second joining elements (130) between the casing (1) and the seat (2).

This application is a Continuation of application Ser. No. 11/284,057, filed 21 Nov. 2005, and which applications are incorporated herein by reference.

### FIELD OF THE INVENTION

The invention refers to a ball joint device of the type used in automotive industry.

### BACKGROUND OF THE INVENTION

Different embodiments disclosing ball joint devices are known in the state of the art.

European patent EP 0481212 shows a ball joint with a ball head, a pivot pin and a ball joint pin housed in a joint casing with a pot-shaped interior, in which it can be moved in a pivoting manner. The ball joint is assembled in a sliding manner in a bearing joined to the joint casing. The device has an annular projection radially extending outward touching the front face of the side of the opening of the joint casing.

However, the embodiments proposed in the state of the art require a precise adjustment both in the manufacture and in the subsequent assembly of the components of the device. This high degree of precision in the manufacture is necessary because it could even occur that the assembly is not possible if the tolerances of the components are too broad or if, even in the case of being more restrictive, the manufactured parts do not comply with said design tolerances; these tolerances will also have an effect on the functioning of the device.

Ball joint devices with inappropriate tolerances cause a series of inadmissible flaws. In addition to being noticeable in a recently manufactured device, these flaws imply a premature deterioration of the device, shorten its useful life and affect the use of the device.

Another feature which ball joint devices must have is leak-tightness. Leak-tightness must be assured both through the adjustment of the components themselves of the ball joint, the design and manufacture tolerances of said components becoming important again, and through the use of auxiliary elements. These auxiliary elements are usually protective domes with their corresponding retaining or sealing elements joining said protective domes with the rest of the components of the ball joint device.

Another additional feature which ball joint devices must have is modularity, this being understood as the ability to constitute a module integrated in a system which said ball joint device is a part of. The devices known in the state of the art have a design and construction which does not facilitate this ability to be integrated in a system in a manner easily adaptable to different systems, given that to that end, they require that the system itself is modified.

### SUMMARY OF THE INVENTION

The present invention proposes a ball joint device solving the drawbacks in the state of the art set forth above.

The design of the joining means and the contact areas of the components of the ball joint device on the joint surfaces assures the leak-tightness required in this type of devices. Said joining means also allow simplifying the process of manufacturing the device, given that leaks in the contact areas are absorbed by the configuration itself of said means; the notching or grooving included in the contact areas between the casing and the ball joint seat.

The relationship between the casing and the seat can also allow the casing to be designed such that it can be adapted to different applications according to the system in which the ball joint device is going to be incorporated.

On the other hand, the casing and the seat define a housing in which the protective dome is joined at one of its ends to the ball joint device; the use of a retaining element for said protective dome is thus prevented, achieving a reduction of the cost of the device, both by decreasing the number of components and by simplifying the assembly.

According to a first aspect, the invention describes a ball joint device comprising:
a ball joint comprising a first substantially ball-shaped ball joint portion and a second ball joint portion having a rod shape;
a ball joint seat comprising:
   a first seat housing to house the first ball joint portion, said first seat housing being configured to allow a sliding movement of the first ball joint portion in said first seat housing;
   a first seat end comprising a first seat opening configured to allow the first ball joint portion to be introduced in said first seat housing;

a casing comprising:
a first casing housing to house the seat, said first casing housing being configured to prevent relative movement between the casing and the seat;
a first casing end comprising a first casing opening configured to allow the seat to be introduced in the first casing housing;
   characterized in that:

the casing comprises:
a second casing end opposite to the first casing end comprising first joining means between the casing and seat;
an intermediate portion in the first casing housing between the first casing end and the second casing end, said intermediate portion comprising second joining means between the casing and the seat.

The first joining means can comprise a frustoconical portion in the casing and a conjugate frustoconical portion in the seat to hold the seat to the casing.

The frustoconical portion in the casing and the conjugate frustoconical portion in the seat can be provided with grooving, a striated surface, for:

assuring a fixing between the casing and the seat;

preventing relative movement between the casing and the seat;

sealing a first peripheral contact surface between the casing and the seat.

The first joining means can also comprise an annular projection in the casing and a first annular groove in the seat for holding the seat to the casing.

The annular projection and the annular groove can be located in a first frontal contact surface between the casing and the seat.

The second joining means can further have a grooving for:

assuring a fixing between the casing and the seat;

preventing relative movement between the casing and the seat;

compensating for shape errors of the casing;

sealing a second peripheral contact surface between the casing and the seat.

Optionally, the seat can also comprise a plurality of grooves in a first seat end to facilitate:

an assembly and disassembly of the seat in the casing;

an introduction and removal of the first ball joint portion in the seat.

The seat can also comprise a plurality of channels in an inner surface of the first seat housing, said channels being configured to allow a distribution of a lubricant between the first ball joint portion and the inner surface of the first seat housing.

Further, the device of the invention can comprise a protective dome to protect the ball joint device.

In that case, the device of the invention can comprise a sealing ring to hold a first end of the protective dome to the ball joint.

On the other hand, the protective dome can comprise a plurality for annular grooves in the manner of a labyrinthine seal in a contact surface between the first end and the ball joint to assure leak-tightness between the protective dome and the ball joint.

The device of the invention can further comprise:

housing means to house a second end of the protective dome, said housing means comprising:

a second annular groove in the casing;

a third annular groove in the seat;

to define an annular cavity having a volume equal to the volume of the second end of the protective dome for;

assuring leak-tightness between the casing, the seat and the protective dome;

assuring a fixing of the protective dome to the casing and the seat.

In the device of the invention, the casing can be of a material selected from:

thermoplastic plastic;

thermosetting plastic;

plastic matrix composite material;

cast iron material;

wrought iron material;

welded iron material;

aluminum;

magnesium;

and combinations thereof.

The casing can comprise a body formed by a plurality of parts.

In the device of the invention, the ball joint seat can be of a material selected from:

thermoplastic plastic;

thermosetting plastic;

alloy cast iron;

bronze;

sintered material;

aluminum;

magnesium;

and combinations thereof.

The ball joint seat and casing can be joined by means of a process selected from welding, riveting and combinations thereof.

In the device of the invention:

the second ball joint portion can be of steel;

the first ball joint portion can be of a material selected among:

steel;

thermosetting plastic;

aluminum alloy;

plastic;

and combinations thereof.

In the device of the invention, the protective dome can be of an elastomeric material selected from:

natural rubber;

synthetic rubber;

plastic;

injectable polyurethane;

and combinations thereof.

In the device of the invention, the sealing ring can be of a material selected from:

steel;

stainless steel;

natural rubber;

synthetic rubber;

plastic;

polyurethane;

and combinations thereof.

### BRIEF DESCRIPTION OF THE DRAWINGS

Very briefly described below are a series of drawings aiding in better understanding the invention and which are expressly related to an embodiment of said invention presented as a non-limiting example thereof.

FIG. 1 shows a cutaway view of the device of the invention showing the different components assembled.

FIG. 2 shows a perspective view of the protective dome from the side of the first end of said protective dome and of the sealing ring.

FIG. 3 shows a perspective view of the protective dome from the side of the second end of said protective dome.

FIG. 4 shows a perspective view of the ball joint.

FIG. 5 shows a perspective view of the seat from the side of the first end of said seat.

FIG. 6 shows a perspective view of the seat from the side of the second end of said seat.

FIG. 7 shows a perspective view of the casing from the side of the first end of said casing.

FIG. 8 shows a perspective view of the casing from the side of the second end of said casing.

### DETAILED DESCRIPTION OF THE PREFERRED EMBODIMENTS

A preferred embodiment of the invention is described below with the aid of the figures.

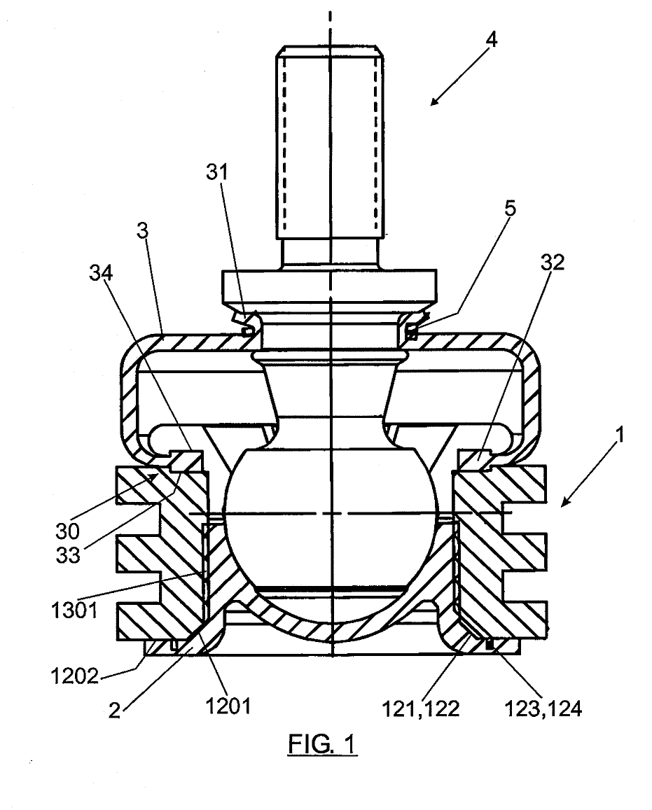

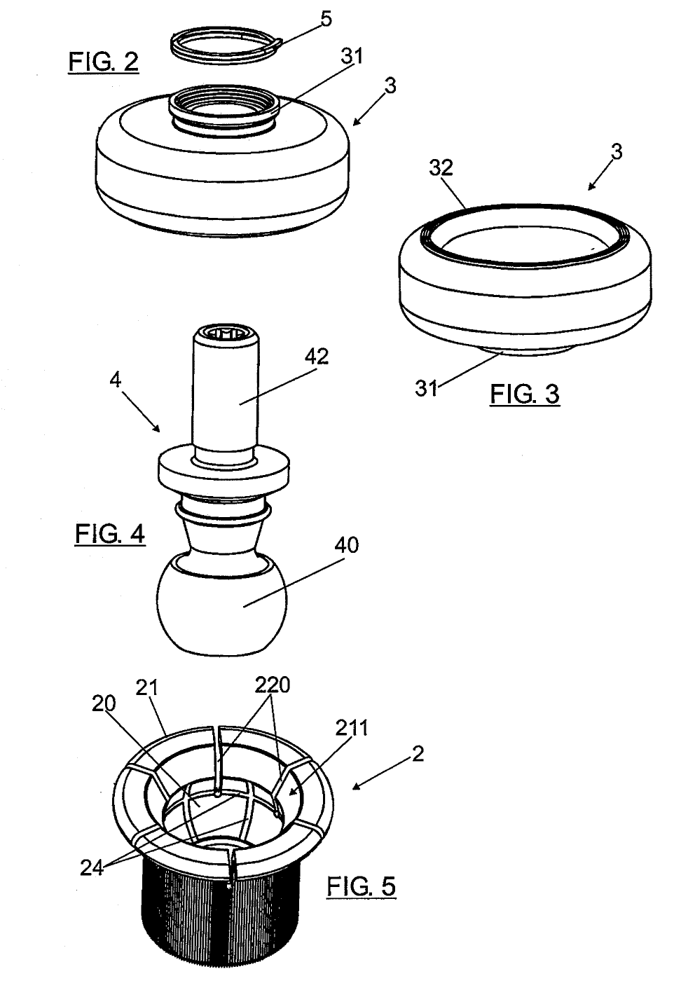

FIG. 1 depicts an embodiment of the device of the invention in which the different components are shown assembled.

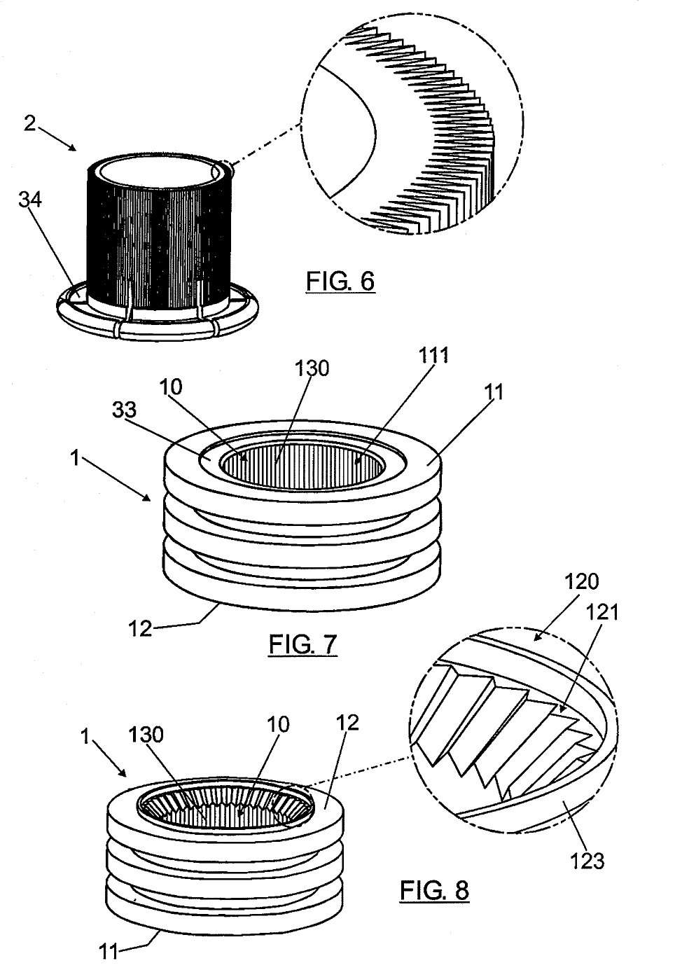

In FIGS. 5 and 6, the seat 2 is shown in its configuration before being assembled in the device; in FIG. 1, the seat 2 after having been introduced in the housing 10 of the casing 1 can be observed. In this sense, FIGS. 5 and 6 show an area of the seat 2 which once formed, together with the second casing 1 end 12, constitutes the first frontal contact surface 1202 and the first peripheral contact surface 1201.

The joint between the casing 1 and the ball joint seat 2 is carried out according to the materials of said casing 1 and seat 2. If the joint between the materials is plastic-plastic, the joint will be welding; should one of the materials not be plastic, the joint will be riveting.

As can be seen in FIG. 1, there are three contact surfaces 1201, 1202 and 1301 between the casing 1 and the seat 2 in which the joint between said components of the device has been carried out.

In the peripheral contact surfaces 1201 and 1301, both the casing 1 and the seat 2 incorporate notching. FIGS. 5 and 6 show the notching in the seat 2, whereas the notching of the casing 1 can be seen in FIGS. 7 and 8.

In contact surface 1202, the casing 1 incorporates an annular projection 123, whereas the seat 2 incorporates an annular groove 124. The annular groove 124 can also be carried out in the casing 1, the seat 2 then incorporating the annular projection 123.

In FIG. 1, the design of the housing means 30 can be observed. Said housing means allow housing a second end 32 of the protective dome 3, preventing using an additional mechanism, such as a sealing or retention ring, to secure the second end 32 of the protective dome 3. Said housing means 30 comprise:

a second annular groove 33 in the casing 1;

a third annular groove 34 in the seat 2;

Said second annular groove 33 and third annular groove 34 define an annular cavity having a volume equal to the volume of the second end 32 of the protective dome 3. Thus, when the protective dome 3 is assembled in the device, the second end 32 becomes deformed in order to occupy the volume defined by the second annular groove 33 and third annular groove 34. With this arrangement:
the static and dynamic leak-tightness between the casing 1, the seat 2 and the protective dome 3 is assured;
a fixing of the protective dome 3 to the casing 1 and the seat 2 is assured.

In FIG. 1, it can be observed how the joint of the protective dome 3 to the ball joint 4 is carried out by means of the sealing ring 5. Said joint is of the sliding type and assures the required leak-tightness and fixing in the device.

FIG. 5 shows the channels 24 engraved in the inside wall or inner surface of the first housing 20 of the seat 2. Said channels 24 allow for the distribution of a lubricant between the first ball joint portion 40 and the inner surface of the first seat housing 20.

1. A ball joint device comprising:
a ball joint comprising a first substantially ball-shaped ball joint portion and a second ball joint portion having a rod shape;
a ball joint seat comprising:
a first seat housing to house the first ball joint portion, said first seat housing being configured to allow a sliding movement of the first ball joint portion in said first seat housing;
a first seat end comprising a first seat opening configured to allow the first ball joint portion to be introduced in said first seat housing;
a casing comprising:
a first casing housing to house the seat, said first casing housing being configured to prevent relative movement between the casing and the seat;
a first casing end comprising a first casing opening configured to allow the seat to be introduced in the first casing housing;
wherein:
the casing comprises:
a second casing end opposite to the first casing end comprising first joining means between the casing and the seat;
an intermediate portion in the first casing housing between the first casing end and the second casing end, said intermediate portion comprising second joining means between the casing and the seat.

2. The device of claim 1, wherein the first joining means comprise a frustoconical portion in the casing and a conjugate frustoconical portion in the seat to hold the seat to the casing.

3. The device of claim 2, wherein the frustoconical portion in the casing and the conjugate frustoconical portion in the seat further comprise grooving for:
assuring a fixing between the casing and the seat;
preventing relative movement between the casing and the seat;
sealing a first peripheral contact surface between the casing and the seat.

4. The device of claim 1, wherein the first joining means further comprise an annular projection in the casing and a first annular groove in the seat to hold the seat to the casing.

5. The device of claim 4, wherein the annular projection and the annular groove are located in a first frontal contact surface between the casing and the seat.

6. The device of claim 1, wherein the second joining means further comprise grooving for:
assuring a fixing between the casing and the seat;
preventing relative movement between the casing and the seat;
compensating for shape errors of the casing;
sealing a second peripheral contact surface between the casing and the seat.

7. The device of claim 1, wherein the seat further comprises a plurality of grooves in a first seat end to facilitate:
an assembly and disassembly of the seat in the casing;
an introduction and removal of the first ball joint portion in the seat.

8. The device of claim 1, wherein the seat further comprises a plurality of channels in an inner surface of the first seat housing, said channels being configured to allow a distribution of lubricant between the first ball joint portion and the inner surface of the first seat housing.

9. The device of claim 1, further comprising:
a protective dome to protect the ball joint device.

10. The device of claim 9, further comprising:
a sealing ring to hold a first end of the protective dome to the ball joint.

11. The device of claim 9, wherein the protective dome further comprises a plurality of annular grooves in the manner of a labyrinthine seal in a contact surface between the first end and the ball joint to assure leak-tightness between the protective dome and the ball joint.

12. The device of claim 9, further comprising:
housing means to house a second end of the protective dome, said housing means comprising:
a second annular groove in the casing;
a third annular groove in the seat;
to define an annular cavity having a volume equal to the volume of the second end of the protective dome for:
assuring leak-tightness between the casing, the seat and the protective dome;
assuring a fixing of the protective dome to the casing and the seat.

13. The device of claim 1, wherein the casing is of a material selected from:
thermoplastic plastic;
thermosetting plastic;
plastic matrix composite material;
cast iron material;
wrought iron material;
welded iron material;
aluminum;
magnesium;
and combinations thereof.

14. The device of claim 1, wherein the casing comprises a body formed by a plurality of parts.

15. The device of claim 1, wherein the ball joint seat is of a material selected from:
thermoplastic plastic;
thermosetting plastic;
alloy cast iron;
bronze;
sintered material;
aluminum;
magnesium;
and combinations thereof.

16. The device of claim 1, wherein the casing and the ball joint seat are joined by means of a process selected from welding, riveting and combinations thereof.

17. The device of claim 1, wherein:
the second ball joint portion is of steel;
the first ball joint portion is of a material selected from:
steel;
thermosetting plastic;
aluminum alloy;
plastic;
and combinations thereof.

18. The device of claim 9, wherein the protective dome is of an elastomeric material selected from:
natural rubber;
synthetic rubber;
plastic;
injectable polyurethane;
and combinations thereof.

19. The device of claim 10, wherein the sealing ring is of a material selected from:
steel;
stainless steel;
natural rubber;
synthetic rubber;
plastic;
polyurethane;
and combinations thereof.
